(19) United States
(12) Patent Application Publication
(10) Pub. No.: US 2012/0305623 A1
(43) Pub. Date: Dec. 6, 2012

(54) MAGAZINE UNIT FOR STRIPS OF FIXING MEANS

(75) Inventor: Gerhard Kuchler, Hamburg (DE)

(73) Assignee: ILLINOIS TOOL WORKS INC., Glenview, IL (US)

(21) Appl. No.: 13/513,095

(22) PCT Filed: Dec. 27, 2010
(86) PCT No.: PCT/US2010/062120

§ 371 Date: Aug. 7, 2012

(30) Foreign Application Priority Data
Dec. 28, 2009 (DE) 20 2009 017 660.6

(51) Int. Cl. B25C 1/00

(52) U.S. Cl. 227/120

(57) ABSTRACT

A magazine unit for supplying strips of fixing elements to a driving assembly includes a magazine shaft in which the strips are magazined one on top of another, and, underneath the magazine shaft, a fixing-element support via which the strips can be fed along their longitudinal axis to the driving assembly. In the lower region of the magazine shaft, a separating unit, with which the magazined strips can be released individually to the fixing-element support, is arranged to be coupled mechanically to a feed slide such that the feed slide, in a triggering movement, causes the strip located in the lowest magazine position to be released to the fixing-element support.

The present invention relates to a magazine unit for strips of fixing means, such as nails or the like, according to the preamble of claim 1.

The magazine unit in question is assigned to a driving module for driving magazined fixing means. In the mounted state, the magazine unit supplies strips of fixing means to the driving module.

The fixing means can be screws, pins or nails, in particular corrugated nails. The fixing means are produced in strips in the present case, wherein the longitudinal extent of the strips is perpendicular to the driving direction of the fixing means. In this case, the fixing means combined to form strips are pressed in, adhesively bonded or the like.

The known magazine unit (DE 36 40 372 C2), on which the invention is based, is part of a driving module which can be used in a mobile manner in manual operation or in a stationary manner. It is provided with a magazine shaft, in which the strips are magazined in a manner lying flat one on top of another. In the lower region of the magazine shaft there is arranged a separating unit, with which the magazined strips can be released individually to a fixing-means support. In order to transport the strips further to the driving assembly, provision is made of a feed slide, which, in a transporting movement, comes into engagement with the strip released in each case. The separating unit is provided with two flaps, wherein one flap serves to release the strip located in the lowest magazine position and the other flap serves to retain the remaining strips so that the released strip can be fed in the magazine shaft in a manner free from the remaining strips. A separate pneumatic piston drive is assigned to each of the two flaps.

With the known magazine unit, when the two flaps are activated in a suitable manner, a high cycle rate with a high level of operational reliability can be achieved. However, a disadvantage is the fact that the separating unit has a relatively complicated structure, namely requires a complicated activation means and two pneumatic piston drives.

The invention is based on the object of configuring and developing the known magazine unit such that its structure is optimized from a cost point of view.

The above object is achieved in the case of a magazine unit according to the preamble of claim 1 by the features of the characterizing part of claim 1.

What is essential is the consideration that a movement of the feed slide can be used in order to trigger the release of the strip located in the lowest magazine position. As proposed, the separating unit is or can be coupled mechanically to the feed slide such that the feed slide, in a triggering movement, causes the strip located in the lowest magazine position to be released to a fixing-means support.

The mechanical coupling, as proposed, of the separating unit to the feed slide means that no separate drive is necessary for releasing the strip located in the lowest magazine position, since, as proposed, the feed slide is used twice.

In the preferred configuration according to claim 4, the separating unit is provided with a releasing unit and with a retaining unit, wherein the releasing unit serves to release the in each case lowest strip while the retaining unit retains the remaining strips located in the magazine shaft. The releasing unit is coupled mechanically to the feed slide such that, in the triggering movement, the feed slide causes the above release.

A particularly robust configuration of the releasing unit, having in particular two flaps, which can be brought into engagement in each case with a guide contour of the feed slide, is the subject matter of claims 9 to 11. Such mechanical activation of the releasing unit, in this case the flaps, leads to a very particularly high level of operational reliability.

An optimal configuration with regard to the guidance of the strips in the region of the releasing unit is the subject matter of claims 12 to 14. Here, the flaps engage in the magazine shaft via locking tongues through slots in the respective wall of the magazine shaft. With the preferred configuration of the slots according to claim 14, “catching” of the strips at the slots is avoided in a particularly effective manner.

The invention is explained in more detail in the following with reference to an exemplary embodiment illustrated in the drawing, in which:

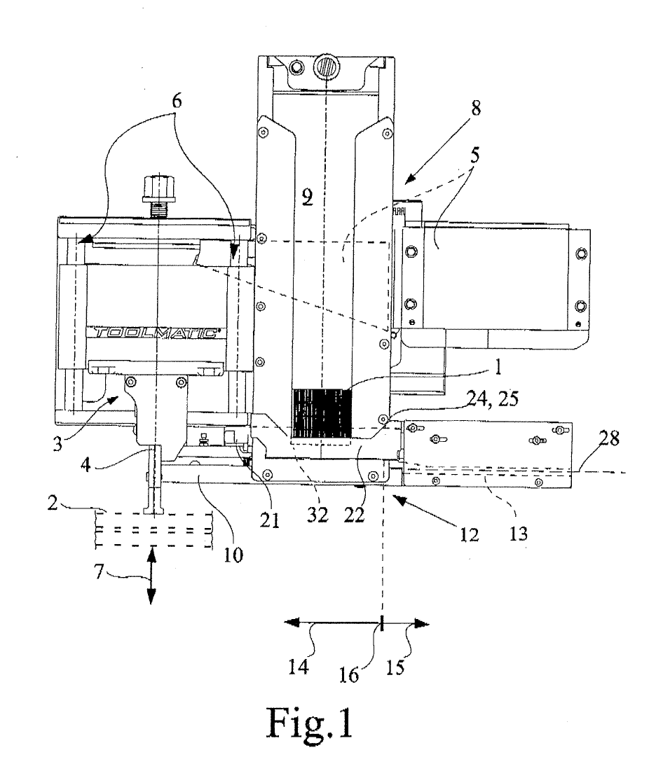

FIG. 1 shows a front view of a driving module to which a magazine unit as proposed is assigned,

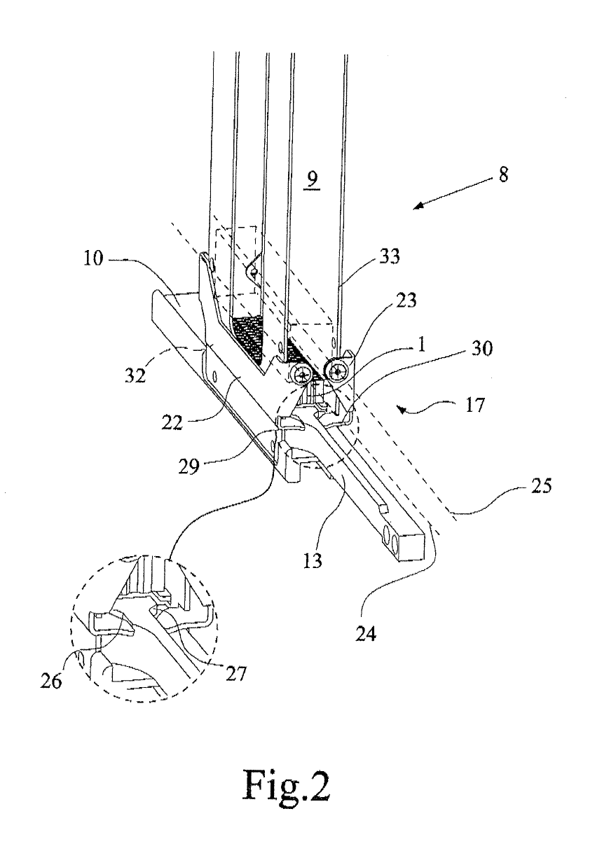

FIG. 2 shows a perspective view of the magazine unit according to FIG. 1 as such in the partially dismantled state before the release,

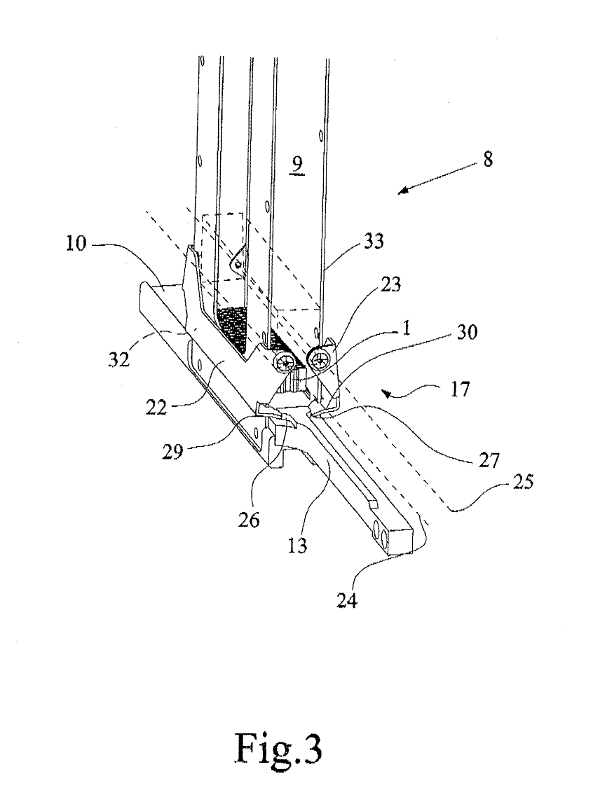

FIG. 3 shows a perspective view of the magazine unit according to FIG. 1 as such in the partially dismantled state during the release,

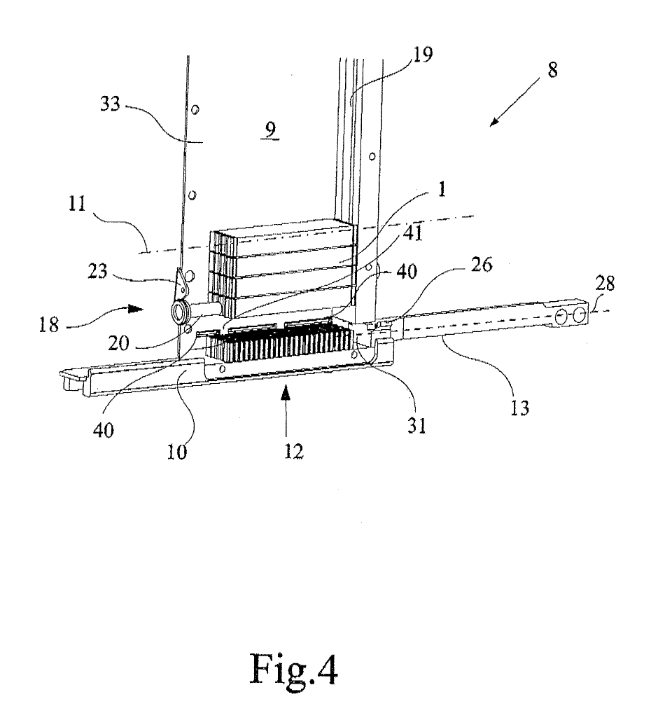

FIG. 4 shows a perspective view of the magazine unit according to FIG. 1 as such in the partially dismantled state after the release, and

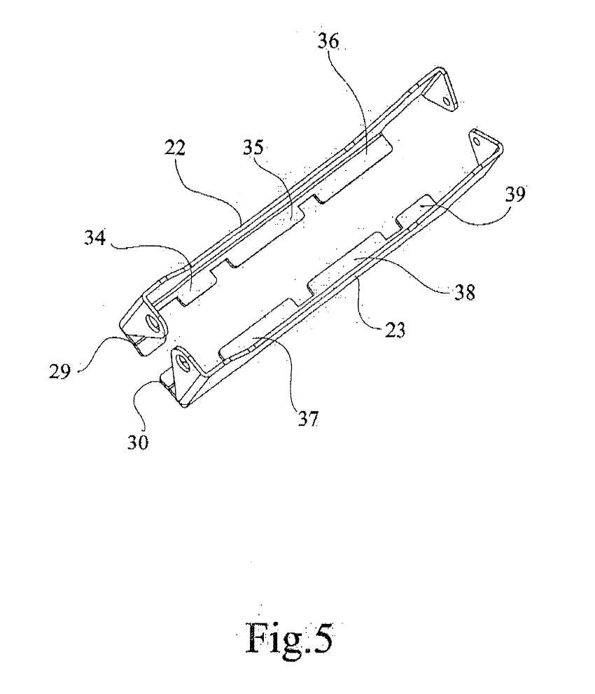

FIG. 5 shows a perspective view of the flaps of the releasing unit of the magazine unit according to FIG. 1.

It should be pointed out in advance that FIGS. 2 to 4 show the arrangement as proposed in the partially dismantled state in order to make the function of individual components clear. The complete arrangement results in each case from viewing FIGS. 1 to 5 together. Furthermore, it is important in order to understand FIGS. 2 and 3 correctly that a part of the magazined strips 1 is merely indicated in dashed lines.

The driving module illustrated in FIG. 1 is suitable for driving any possible magazined fixing means 1 into workpieces 2. These fixing means are screws, nails, in particular corrugated nails, which are produced in each case in strips 1. Such fixing means 1, produced in strips 1, in the form of corrugated nails are shown in FIGS. 1 to 4.

The driving module is provided here with a driving assembly 3, which serves to drive the fixing means. The driving assembly 3 is provided for this purpose with a tool head 4, in which a driver punch (not shown) runs. The driver punch comes into engagement individually with the laterally supplied fixing means 1 and presses the fixing means 1 in a corresponding manner into the workpiece 2.

In order to press the driving assembly 3 onto the workpiece 2, the driving assembly 3 can be pressed as such onto the workpiece by means of a pressing drive 5 in order to avoid displacement of the workpiece before the driving of the fixing means 1. For this purpose, the driving assembly 3 is guided in a displaceable manner via an assembly guide 6 in the driving direction 7. The basic construction of a driving module having such a driving assembly 3 is shown in publication FI 8 444 6 A1.

The driving module illustrated in FIG. 1 has, besides the driving assembly 3, a magazine unit 8, which in the present case is in the foreground. The magazine unit 8 as proposed can be used with numerous variants of driving assemblies 3.

The magazine unit 8 has a magazine shaft 9, in which the strips 1 are magazined one on top of another. This can be gathered most clearly from the illustration in FIG. 1.

Underneath the magazine shaft 9 extends a fixing-means support 10 via which the strips 1 can be fed, to the left in FIG. 1, along their longitudinal axis 11 to the driving assembly 3. The fixing-means support 10 is a shaft, which extends horizontally in FIG. 1 and in which the strips 1 are guided longitudinally.

Provided in the lower region of the magazine shaft 9 is a separating unit 12, with which the magazined strips 1 can be released individually to the fixing-means support 10.

After a strip 1 has been released by the separating unit 12, the strip 1 falls onto the fixing-means support 10, as a result of which the remaining strips 1 move down in each case in a stepwise manner.

Provided in the region of the fixing-means support 10 is a feed slide 13 which, in a transporting movement 14, comes into engagement with a strip 1 deposited at the fixing-means support 10 and feeds the strip 1 to the driving assembly 3, in this case to the tool head 4 of the driving assembly 3. The transporting movement is always followed by a return movement.

The preferred configuration of the feed slide 13 can be gathered from viewing FIGS. 1 to 4 together.

What is essential is now that the separating unit 12 is or can be coupled mechanically to the feed slide 13 such that the feed slide 13, in a triggering movement 15, causes the strip 1 located in the lowest magazine position to be released to the fixing-means support 10. Thus the feed slide 13 serves not only to transport the respectively released strip 1 but also to actuate the separating unit 12. This double use of the feed slide 13 enables the structure of the magazine unit 8 to be optimized from a cost point of view.

It can be gathered from the illustration in FIG. 1 that the transporting movement 14 is oriented in the opposite direction to the triggering movement 15. In this case, the two movements 14, 15 are assigned different regions of movement. Here, and preferably, the regions of movement of the two movements 14, 15 border one another, namely in the starting position 16 of the feed slide 13. Both the transporting movement 14 and the triggering movement 15 proceed from one and the same starting position 16 of the feed slide 13.

Of interest in the exemplary embodiment illustrated and to this extent preferred is the fact that, during the triggering movement 15, the feed slide 13 is always located outside the region on the fixing-means support 10 that is assigned to a strip 1 (FIG. 4) that has just been released. Thus, the arrangement can have a particularly high level of operational reliability, since undesired collisions of a released strip 1 with the feed slide 13 cannot occur. In particular, the triggering of the release of a strip 1 by the feed slide 13 is ruled out while the latter is located underneath the magazine shaft 8. Only once the transporting movement 14 has been completed and after the return movement of the feed slide 13 into the starting position 16 does the triggering movement 15 take place. In this connection, it should be pointed out for clarification that an intermediate stop in the starting position 16 is not necessary here.

Depending on the respective constructive boundary conditions, different variants for realizing the separating unit 12 are conceivable. Here, and preferably, it is the case that the separating unit 12 has a releasing unit 17, which only releases the strip 1 located in each case in the lowest magazine position to the fixing-means support 10 when the realising unit 17 is actuated and otherwise retains the strip 1 in the lowest magazine position. FIG. 2 shows the retaining operation, while FIGS. 3 and 4 show the releasing operation. In addition, the separating unit 12 is provided with a retaining unit 18 which only downwardly releases the strip 1 located in the second-lowest magazine position when the retaining unit 18 is actuated and otherwise retains this strip 1 in the second-lowest magazine position.

In normal operational use it is provided that the release by the releasing unit 17 can only take place when at the same time the retaining unit 18 is retaining the remaining strips 1 present in the magazine shaft 9. This situation is shown in FIG. 4. Following the release, which was triggered by the triggering movement of the feed slide 13, the feed slide 13 travels back into the starting position 16 and so the releasing unit 17 is transferred into the unactuated state. From there, the next transporting movement 14 is carried out—preferably without an intermediate stop.

During the transporting movement 14 or the following return movement, the retaining unit 18 can be actuated, and so the remaining strips 1 in the magazine shaft 9 move down, wherein the strip 1 falling into the lowest magazine position is retained by the releasing unit 17. Finally, the retaining unit 18 is transferred into the unactuated state and so the remaining strips 1 in the magazine shaft 9 are retained during the subsequent release.

It is clear from the above explanation that the actuation of the retaining unit 18 preferably takes place during the transporting movement 14 or the return movement into the starting position 16 of the feed slide 13 and so the triggering movement 15 can directly follow the return movement.

In a preferred configuration, the actuation of the retaining unit 18 by the feed slide 13 is triggered in that the feed slide 13 carries out the transporting or return movement. By way of example, the feed slide 13 acts during the transporting or return movement on corresponding valves or sensors, as will be explained below.

It is also clear from the above explanation that the arrangement is preferably made such that actuation of the releasing unit 17 and actuation of the retaining unit 18 are mutually exclusive. If both units were to be actuated simultaneously, all the strips 1 located in the magazine shaft 9 would fall onto the fixing-means support 10, and this would make the feeding of the lowest strip 1 located on the fixing-means support 10 virtually impossible.

Numerous advantageous variants are conceivable for the configuration of the retaining unit 18. Here, and preferably, the retaining unit 18 acts in the non-actuated state on the strip 1 (FIG. 4) located in the second-lowest magazine position in the longitudinal extent 11 thereof and so clamps the strip 1 firmly in the magazine shaft 9. The above longitudinal extent 11 is illustrated in FIG. 4 for the uppermost strip 1 in a manner which is representative for all the other strips. Specifically, the retaining unit 18 clamps the strip 1 against a side wall 19 of the magazine shaft 9.

In the exemplary embodiment illustrated and to this extent preferred, the retaining unit 18 has a clamping bolt 20 which can be brought into clamping engagement in the manner described above with the strip 1 located in the second-lowest magazine position. In this case, the clamping bolt 20 is preferably coupled to a clamping drive 21, which is indicated in FIG. 1 and which here, and preferably, is a pneumatic piston drive. In a particularly simple configuration, as discussed above, the pneumatic piston drive can be activated via the feed slide 13. For this purpose, the feed slide 13 is assigned for example valve switches, with which the feed slide 13 comes into switching engagement during the transporting or return movement and which actuate the piston drive 21. In another variant, the feed slide 13 is assigned microswitches or the like, which trigger during the transporting or return movement and lead to the actuation of an electropneumatic valve unit which is assigned in turn to the piston drive.

In a very particularly simple configuration, it is even provided that, when the feed slide 13 is moved in the advancing direction, a possibly slightly time-delayed actuation of the retaining unit 18 always takes place and when the feed slide 13 is moved counter to the advancing direction, correspondingly no actuation of the retaining unit 18 takes place. The clamping drive 21 assigned to the clamping bolt and a drive assigned to the feed slide 13 can thus basically be activated in parallel, as long as the above possibly necessary time delay is taken into consideration. In the case of pneumatic drives, this parallel switching can be realized in a very particularly simple manner. The components required for activation are thus reduced to a minimum.

The releasing unit 17 can also be realized in a cost-effective manner with a high level of operational reliability with the exemplary embodiment illustrated and to this extent preferred. The basic construction of the releasing unit 17 is based on the realization of at least one flap 22, 23, the flap axis 24, 25 or the flap axes 24, 25 of which is or are oriented in each case substantially parallel to the longitudinal extent 11 of the strip 1 located in the lowest magazine position and which can be brought into retaining engagement with the strip 1 located in the lowest magazine position (FIG. 2). Here, and preferably, the releasing unit 17 is provided with two flaps 22, 23, in order to avoid tilting of the strips 1 while they are retained by the flap 22, 23. This can be brought about best when the two flaps 22, 23 of the releasing unit 17 are arranged opposite one another and can be pivoted in opposite directions in order to release.

This can be gathered from viewing FIGS. 2 and 3 together. The actuation of the releasing unit 17 and thus of the flaps 22, 23 by the triggering movement 14 of the feed slide 13 is realized in a very particularly simple manner in the exemplary embodiment illustrated. The illustrations in FIGS. 2 and 3 reveal that the feed slide 13 has in this case a guide contour 26 which, during the triggering movement 15 of the feed slide 13, comes into engagement with a flap 22 of the releasing unit 17 and pivots the flap 22 into the releasing position illustrated in FIG. 3. Here, and preferably, the feed slide 13 has two guide contours 26, 27 which are assigned in each case to a flap 22, 23 of the releasing unit 17, wherein the guide contours 26, 27, with respect to the advancing axis 28 of the feed slide 13, are arranged and configured in particular in a substantially symmetrical manner with respect to one another.

Here, and preferably, the two flaps 22, 23 are provided with a tongue-like portion 29, 30 for engagement with the feed slide 13. During the triggering movement 15, the tongue-like portions 29, 30 of the flaps 22, 23 slide along the guide contour 26, 27 and follow the curved extent of the two guide contours 26, 27.

Preferably, the feed slide 13 has an engagement surface 31 for engagement with the strip 1 to be fed, wherein the guide contour 26 or the guide contours 26, 27 is or are arranged in the region of the portion of the feed slide 13 that has the engagement surface 31. Thus, the feeding function on the one hand and the actuating function on the other are combined in the relevant portion of the feed slide 13, this allowing a particularly compact construction.

The feed slide 13 is assigned a drive (not shown), which is preferably configured as a pneumatic piston drive. Depending on the prevailing constructive boundary conditions, other drives can be used here.

Good guidance of the strips 1 in the magazine shaft 9 is of great importance, particularly when use is made of strips 1 of corrugated nails, in order reliably to avoid jamming of the strips 1 within the magazine shaft 9. Of course, this also applies to the region of the separating unit 12. It is easy to imagine that tilt-free releasing of the strip 1 located in the lowest magazine position is not without problems.

In order to guide the strips 1, a front wall 32 and a rear wall 33 are in any case provided in the region of the separating unit 12, wherein the flaps 22, 23 are arranged on the outside of the front wall 32 and the rear wall 33 of the magazine shaft 9. In order for them now to be able to come into retaining engagement with the strip 1 located in each case in the lowest magazine position, the flaps 22, 23 have locking tongues 34-39, which protrude into the magazine shaft 9 through openings, in this case slots 40 adapted in terms of shape and size to the locking tongues 34-39, provided in the respective wall 32, 33. The slots 40 assigned to the locking tongues 34-39 are indicated in FIG. 4.

Preferably, the front wall 32 and the rear wall 33 of the magazine shaft 9 have slots 40, which are arranged in each case in particular in a row, are spaced apart from one another by supporting portions 41, and to which corresponding locking tongues 34-39 of the two flaps 22, 23 are assigned.

The illustration in FIG. 4 reveals the fact that the supporting portions 41 guide the strips 1 over the respective slot width (the width in the vertical direction in FIG. 4), thereby avoiding the strips 1 catching on the slots 40. It is particularly advantageous here that at least some of the slots 40, in this case all of the slots 40, in one wall 32, 33 are located opposite a supporting portion 41 of the respective other wall 33, 32. This offset arrangement of the slots 40 or locking tongues 34-39 further reduces the risk of jamming or catching.

FIG. 5 shows the configuration of the flaps 22, 23 with offset locking tongues. In this case, the locking tongues 34, 35, 36 are arranged in a complementary manner with respect to the locking tongues 37, 38, 39, and the result of this is the offset discussed above of the slots 40 adapted in this case in terms of shape and size to the locking tongues 34-39.

The above aspect of the slots 40 offset with respect to one another or of the locking tongues 34-49 offset with respect to one another is intended, when realized on a magazine unit, also to be claimable as such. In this case it is not necessarily important for the feed slide to be coupled to the separating unit 12, as explained above. However, all the statements made above are otherwise valid in a corresponding manner for this further claimable teaching.

1. A magazine unit for strips of fixing means, such as nails or the like, which in the mounted state supplies strips of fixing means to a driving assembly, wherein there is a magazine shaft in which the strips are magazined one on top of another, and wherein underneath the magazine shaft there extends a fixing-means support via which the strips can be fed along their longitudinal axis to the driving assembly, wherein there is arranged in the lower region of the magazine shaft a separating unit, with which the magazined strips can be released individually to the fixing-means support, as a result of which the remaining strips move down in each case in a stepwise manner, wherein there is a feed slide which, in a transporting movement, comes into engagement with a strip released to the fixing-means support and feeds the strip to the driving assembly, characterized
in that the separating unit is or can be coupled mechanically to the feed slide such that the feed slide, in a triggering movement, causes the strip located in the lowest magazine position to be released to the fixing-means support.

2. The magazine unit as claimed in claim 1, characterized in that the transporting movement is oriented in the opposite direction to the triggering movement, preferably in that both the transporting movement and the triggering movement proceed from one and the same starting position of the feed slide.

3. The magazine unit as claimed in claim 1, characterized in that, during the triggering movement, the feed slide is always located outside the region on the fixing-means support that is assigned to a strip that has just been released.

4. The magazine unit as claimed in claim 1, characterized in that the separating unit has a releasing unit, which only releases the strip located in each case in the lowest magazine position to the fixing-means support when it is actuated and otherwise retains it in the lowest magazine position, in that the separating unit has a retaining unit which only downwardly releases the strip located in the second-lowest magazine position when it is actuated and otherwise retains it in the second-lowest magazine position, and in that the releasing unit is mechanically coupled to the feed slide such that, in the triggering movement, the feed slide causes the strip located in each case in the lowest magazine position to be released to the fixing-means support.

5. The magazine unit as claimed in claim 4, characterized in that the arrangement is made such that actuation of the releasing unit and actuation of the retaining unit are mutually exclusive.

6. The magazine unit as claimed in claim 4, characterized in that the retaining unit acts in the non-actuated state on the strip located in the second-lowest magazine position in the longitudinal direction thereof and so clamps the strip firmly in the magazine shaft, preferably in that the retaining unit has a clamping bolt which can be brought into clamping engagement with the strip located in the second-lowest magazine position, preferably in that the clamping bolt is coupled to a clamping drive, in particular to a pneumatic piston drive.

7. The magazine unit as claim 4, characterized in that the releasing unit has at least one, preferably two, flaps, the flap axis or the flap axes of which is or are oriented in each case substantially parallel to the longitudinal extent of the strip located in the lowest magazine position and which can be brought into retaining engagement with the strip located in the lowest magazine position.

8. The magazine unit as claimed in claim 7, characterized in that the two flaps of the releasing unit are arranged opposite one another and can be pivoted in opposite directions in order to release.

9. The magazine unit as claimed in claim 7, characterized in that the feed slide has a guide contour which, during the triggering movement of the feed slide, comes into engagement with a flap of the releasing unit and pivots the flap into a releasing position, preferably in that the feed slide has two guide contours which are assigned in each case to a flap of the releasing unit, further preferably in that the guide contours, with respect to the advancing axis of the feed slide, are arranged and configured in a substantially symmetrical manner with respect to one another.

10. The magazine unit as claimed in claim 7, characterized in that the flap or both flaps has or have a portion for engagement with the feed slide.

11. The magazine unit as claimed in claim 1, characterized in that the feed slide has an engagement surface for engagement with the strip to be fed, and in that the guide contour or the guide contours is or are arranged in the region of the portion of the feed slide that has the engagement surface.

12. The magazine unit as claimed in claim 1, characterized in that the magazine shaft for guiding the strips has, in any case in the region of the separating unit, a front wall and a rear wall, and in that the flaps are arranged on the outside of the front wall and the rear wall of the magazine shaft and have locking tongues for retaining engagement with the strip located in each case in the lowest magazine position, said locking tongues protruding into the magazine shaft through openings, in particular slots, provided in the respective wall.

13. The magazine unit as claimed in claim 12, characterized in that the front wall and the rear wall of the magazine shaft have slots, which are arranged in each case in particular in a row, are spaced apart from one another by supporting portions, and to which corresponding locking tongues of the two flaps are assigned.

14. The magazine unit as claimed in claim 13, characterized in that at least some of the slots, preferably all of the slots, in one wall are located opposite a supporting portion of the other wall.
